(19) United States
(12) Patent Application Publication
(10) Pub. No.: US 2007/0124228 A1
(43) Pub. Date: May 31, 2007

(54) Electronic bartering

(76) Inventors: Daniel Elias, Northampton, MA (US); William Bloom, New York, NY (US)

Correspondence Address: MORGAN & FINNEGAN, L.L.P., 3 WORLD FINANCIAL CENTER, NEW YORK, NY, 10281-2101, US

(21) Appl. No.: 10/583,395

(22) PCT Filed: Dec. 29, 2004
(86) PCT No.: PCT/US04/43966

§ 371 Date: Jun. 19, 2006

Related U.S. Application Data
(60) Provisional application No. 60/532,629, filed on Dec. 29, 2003.

(51) Int. Cl. G06Q 40/00

(52) U.S. Cl. 705/37

(57) ABSTRACT

An electronic bartering system and method for facilitating a trade of a first item owned by a first user for a second item owned by a second user when the first user and the second user are connected to a network. The electronic bartering system and method receives a request from the first user, allows the second user to access items owned by the first user, receives a response from the second user, and receives an acceptance from the first user The request identifies the second item and is a potential trade request. The response identifies the first item and is a trade offer The trade comprises the potential trade request, the trade offer, and the acceptance. Completion of the trade further includes receiving a confirmation from both the first user and the second user

This application hereby claims priority to U.S. Provisional Patent Application Ser. No. 60/532,629, entitled “Electronic Bartering,” which is hereby incorporated by reference.

### FIELD OF THE INVENTION

The present invention relates, in general, to the exchange of goods between parties utilizing a wired or wireless communication network, including but not limited to the internet. In particular, the present invention is a system and method for facilitating barter transactions.

### BACKGROUND OF THE INVENTION

Bartering is a trade between two parties that typically involves the exchange of one commodity for another commodity. For bartering to benefit both parties, the trade must be a “fair” exchange. Thus, the exchanged commodities must have an equal value.

Bartering is the basis for most systems of commerce. The American colonists relied primarily on a bartering system due to the scarcity of standardized coin or paper money to exchange beaver pelts, corn, musket balls, nails, tobacco, and deerskins. More recently, people rely upon a bartering system to trade baseball cards, football cards, postage stamps, audio and video recordings, video game cartridges, and books.

The commercial availability of the Internet and World Wide Web has spawned an electronic commerce revolution. Businesses throughout the world use electronic information technologies to conduct business with their trading partners. Some businesses use a standardized form of electronic data interchange (EDI) to communicate with their trading partners, negotiate and complete trades, and manage inventories. Other businesses rely on electronic commerce technology to advertise their product, provide a forum for customers to shop, and take and fulfill orders from the customers.

There is a need for an electronic bartering system and method for facilitating a trade of an item owned by one person connected to a network for an item owned by another person connected to the network. The present invention addresses this need.

### SUMMARY OF THE INVENTION

The system and method will rely upon the electronic commerce basis of the Internet to allow a user to publicize (1) a list of items that the user is requesting from other users, and (2) a list of items that the user has posted on the system for bartering. The other users can select from the list of items that the user has posted those items for which they want to trade.

The system and method allow a user to peruse the aggregated collection of all users. Also, the systems only allows one user to view the collection of another user when a potential trade is in place. The system and method also allows either party to the trade to decline a trade based on a trading history of the other party to the trade, the items available in that party's collection, and/or the stated condition of said items.

A computer system, method and computer program product for facilitating a trade of a first item owned by a first user for a second item owned by a second user when the first user and the second user are connected to a network. The method comprises receiving a request from the first user, allowing the second user to access items owned by the first user, receiving a response from the second user, and receiving an acceptance from the first user. The request identifies the second item and is a potential trade request. The response identifies the first item and is a trade offer. The trade comprises the potential trade request, the trade offer, and the acceptance. Completion of the trade further includes receiving a confirmation from both the first user and the second user.

### BRIEF DESCRIPTION OF THE DRAWINGS

The accompanying figures best illustrate the details of the electronic bartering system and method for facilitating a trade of a first item owned by a first user for a second item owned by a second user, both as to its structure and operation. Like reference numbers and designations in these figures refer to like elements.

FIG. 1 is a network diagram that illustrates the hardware components that form the operating platform for one embodiment of an electronic bartering system for facilitating a trade of a first item owned by a first user for a second item owned by a second user.

FIG. 2 is a block diagram that illustrates the hardware and software components comprising server computer shown in FIG. 1.

FIG. 3 is a flow diagram of an embodiment of a process that facilitates a trade of a first item owned by a first user for a second item owned by a second user.

FIGS. 4A1-4G are exemplary screen representations according to an implementation of bartering system that demonstrates requesting an item from another user and accepting a trade offer in response.

FIGS. 5A-5H are exemplary screen images from an implementation of bartering system that demonstrates receiving a potential trade request from another user and issuing a trade offer in response.

### DETAILED DESCRIPTION OF THE INVENTION

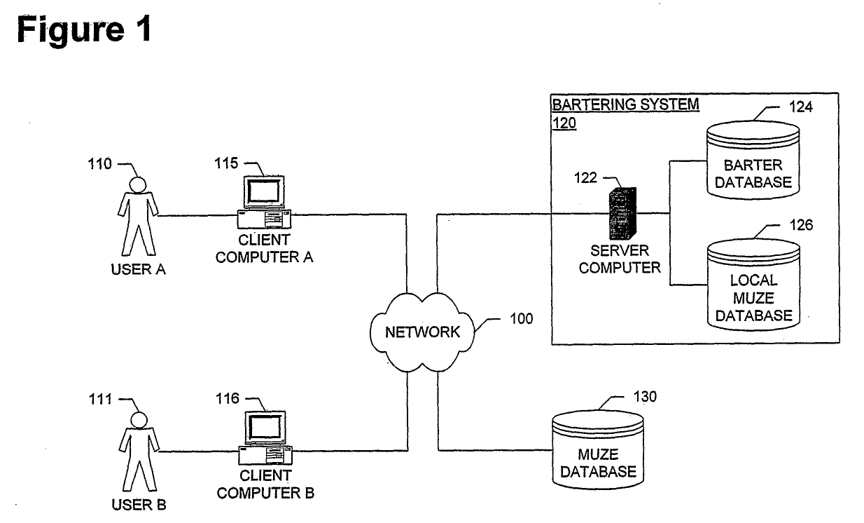

FIG. 1 is a network diagram that illustrates the hardware components that form the operating platform for one embodiment of an electronic bartering system for facilitating a trade of a first item owned by a first user for a second item owned by a second user. As shown in FIG. 1, network 100 is a communication medium connecting client computer A 115, client computer B 116, bartering system 120, and Muze database 130. Bartering system 120 comprises server computer 122, barter database 124, and local Muze database 126. Client computer A 115 is a general-purpose personal computer, workstation, or laptop configured to connect to network 100. User A 110 operates client computer A 115 to communicate with server computer 122. Client computer B 116 is a general-purpose personal computer, workstation, or laptop configured to connect to network 100. User B 111 operates client computer B 116 to communicate with server computer 122. Server computer 122 is a general-purpose network computer that manages network resources and accepts connections from devices such as client computer A 115 and client computer B 116 via network 100. Server computer 122 connects to barter database 124 to store and retrieve data related to electronic bartering transactions. Server computer 122 also connects to local Muze database 126 to retrieve data that describes the items exchanged via the electronic bartering system. Server computer 122 also connects to Muze database 130 to periodically retrieve data updates for local Muze database 126. In one embodiment, the period of the updates is a configurable parameter. For example, the configuration may specify the period of the updates to occur hourly, daily, weekly, monthly, quarterly, semiannually, or annually.

Network 100 shown in FIG. 1 is a public communication network. However, bartering system 120 also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA) or Code Division Multiple Access (CDMA) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization, such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

FIG. 1 shows one embodiment of bartering system 120 connecting to local Muze database 126 and Muze database 130. Muze is an organization that provides information solutions that supply the core data for all commercially available music, books, videos, and games. The Muze data provides value-added information such as reviews, biographies, notes, and annotations. The Muze data provides the necessary information that consumers need to make educated purchasing decisions and the crucial information that music service providers and retailers need to increase their sales and fulfill transactions. Muze database 130 is a commercial database that includes descriptions of the items that user A 110 and user B 111 may exchange via the electronic bartering system. For example, Muze database 130 includes a movie database, an audio database, a book database, and a video-game database. In another embodiment, Muze database 130 includes one or more commercial databases, where each commercial database includes data for a specific type of item. In yet another embodiment, Muze database 130 is a web portal that supplements a commercial database with customized data. In other embodiments, bartering system 120 may connect to any media database that will provide similar information to local Muze database 126 and Muze database 130. In yet other embodiments, bartering system 120 retrieves real-time data from Muze database 130 and does not require a connection to local Muze database 126.

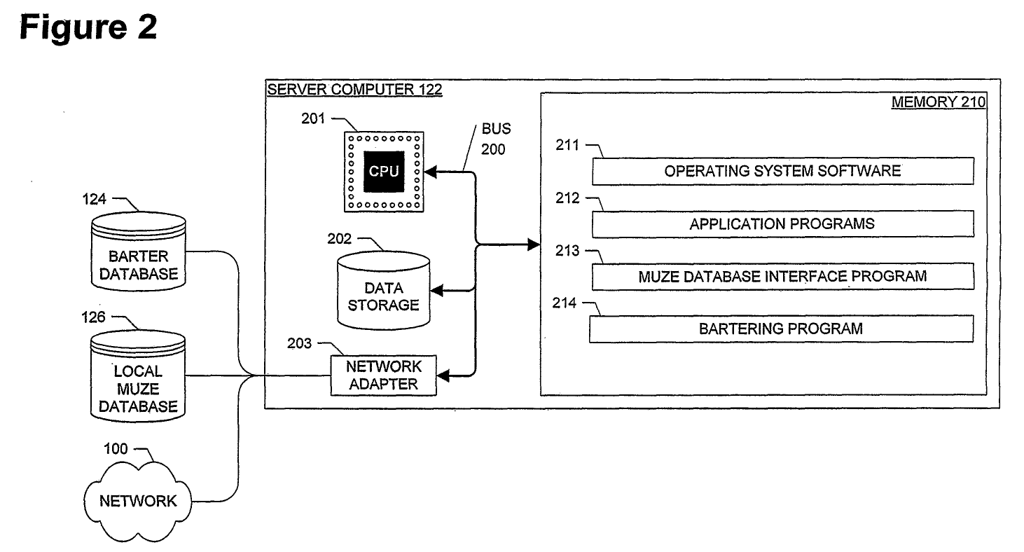

FIG. 2 is a block diagram that illustrates the hardware and software components comprising server computer 122 shown in FIG. 1. Server computer 122 is a general-purpose network computer that manages network resources and accepts connections from devices such as client computer A 115 and client computer B 116 via network 100. Bus 200 is a communication medium that connects central processing unit (CPU) 201, data storage 202, and network adapter 203 to memory 210. Network adapter 203 also connects to barter database 124, local Muze database 126, and network 100 and is the mechanism that facilitates the passage of network traffic between bartering system 120 and barter database 124, local Muze database 126, and network 100. CPU 201 performs the disclosed methods by executing the sequences of operational instructions that comprise each computer program resident in, or operative on memory 210.

FIG. 2 illustrates barter database 124, local Muze database 126, and data storage 202 as separate devices. In another embodiment, bartering system 120 stores the data in a single physical device that includes a separate logical partition for barter database 124, local Muze database 126, and data storage 202. FIG. 2 also illustrates barter database 124 and local Muze database 126 as external devices, however it is to be understood that in another embodiment these devices may each be internal to bartering system 120. FIG. 2 also illustrates data storage 202 as an internal device, however it is to be understood that in another embodiment this device may be external to bartering system 120 and accessible via a network connection. Bartering system 120 also contemplates distributing barter database 124, local Muze database 126, and data storage 202 over multiple storage devices to suit efficiency, performance, backup, and data warehousing requirements. In one embodiment, barter database 124 and local Muze database 126 utilize a relational database management system such as Oracle 9i (version 9.2) by Oracle™. Another embodiment of barter database 124 and local Muze database 126 may utilize a different database management tool that is either homegrown or publicly available and traded. Another embodiment of barter database 124 and local Muze database 126 may utilize an object-oriented database management system such as FrameD, open source software provided by SourceForge.net.

In one embodiment, the configuration of memory 210 includes operating system software 211, application programs 212, Muze database interface program 213, and bartering program 214. These computer programs store intermediate results in memory 210 and transmit final results via bus 200 for storage in and retrieval from barter database 124, local Muze database 126, or data storage 202. It is to be understood that in another embodiment the configuration of memory 210 may not simultaneously include these programs. CPU 201 coordinates loading a program when it is needed, storing intermediate results, transferring data from one program to another, and unloading the program when it is no longer needed.

Operating system software 211 manages the basic operations of server computer 122. These basic operations include apportioning memory 210, prioritizing the execution of system tasks, and managing the communication with CPU 201 and other hardware components of server computer 122. The disclosed invention contemplates the use of the MS-DOS, Unix, and Linux operating systems.

Application programs 212 control and supplement the interaction between a user and server computer 122. Application programs 122 include a web server, a mail server, and network communication protocol software. User A 110 operates a web browser (e.g., Internet Explorer or Netscape Navigator) program resident on client computer A 115 to communicate with a web server (e.g., Apache) resident on server computer 122. Similarly, user B 111 operates a web browser program resident on client computer B 116 to communicate with a web server resident on server computer 122. The web server program transmits and receives data via web pages and a protocol such as the hypertext transfer protocol. The mail server resident on server computer 122 communicates with a mail reader program resident on a client computer to transmit and receive electronic mail messages. Server computer 122 executes the network communication protocol software to transmit and receive network messages with a client computer.

Muze database interface program 213 controls the interaction between web server 122 and a commercial database, such as local Muze database 126 or Muze database 130, that includes descriptions of the items that user A 110 and user B 111 may exchange via the electronic bartering system. In one embodiment, Muze database interface program 213 is an agent program that retrieves web pages from the commercial database, parses the retrieved web page to extract the data necessary for bartering system 120, and serves the parsed data to the user. In another embodiment, Muze database interface program 213 sends a specific database query to the commercial database that returns a customized result set that is forwarded to bartering system 120. Muze database interface program 213 also periodically connects to Muze database 130 to retrieve data updates for local Muze database 126. In one embodiment, the period of the updates is a configurable parameter. For example, the configuration may specify the period of the updates to occur hourly, daily, weekly, monthly, quarterly, semiannually, or annually.

Bartering program 214 includes the program logic for controlling the negotiation of an electronic bartering transaction between two users. The electronic bartering transaction of the disclosed invention contemplates the exchange of an item owned by one user for a similar item owned by another user. In another embodiment, the electronic bartering transaction involves the exchange of an item owned by one user for an item of equal value owned by another user. In one embodiment, the item of equal value is an item of the same type, but in a different condition (e.g., exchanging a digital videodisc (DVD) in excellent condition for a DVD in used condition). In another embodiment, the item of equal value may differ in type, as well as condition (e.g., exchanging a DVD in excellent condition for a video cassette recorder (VCR) tape in excellent condition).

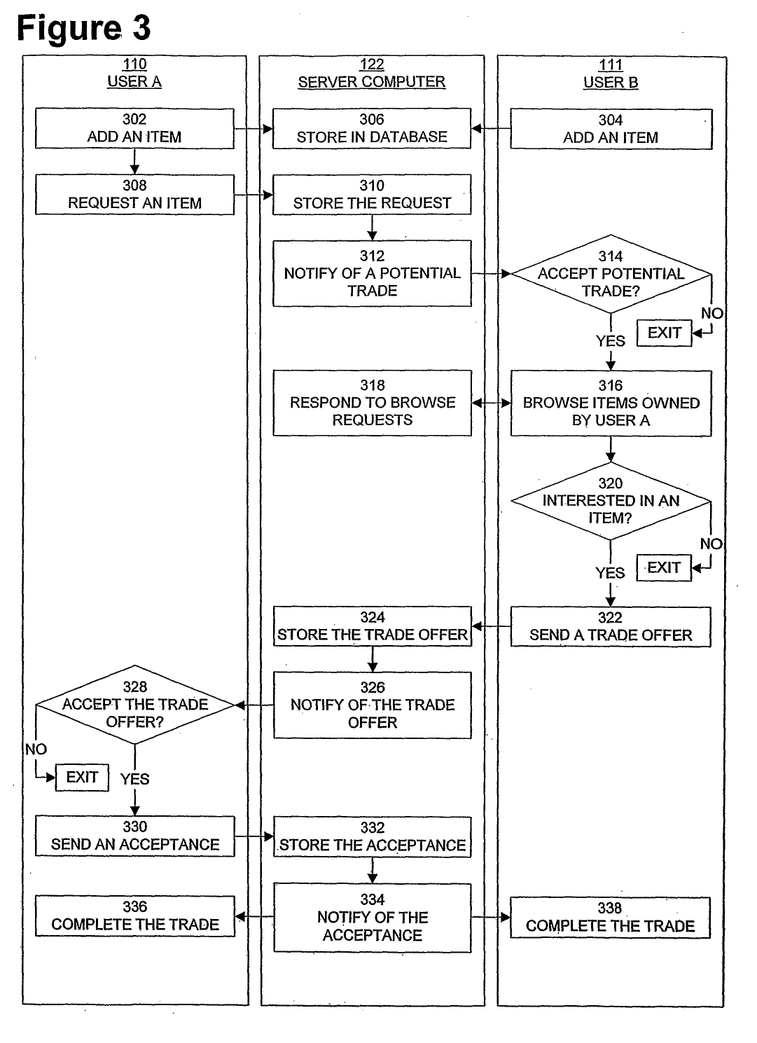

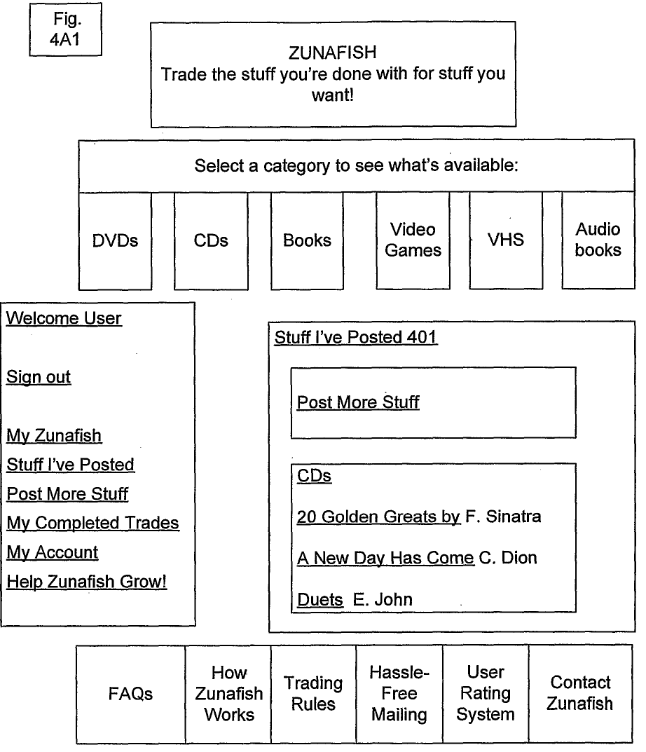

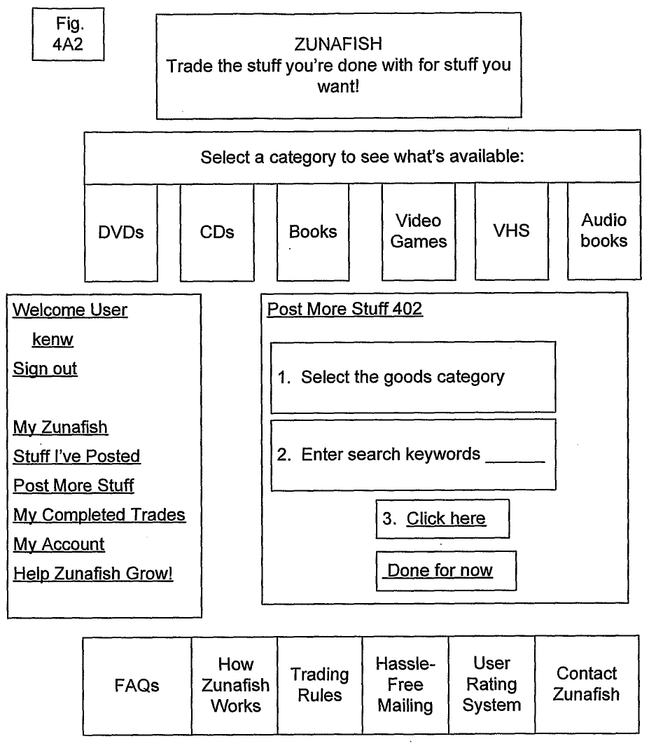

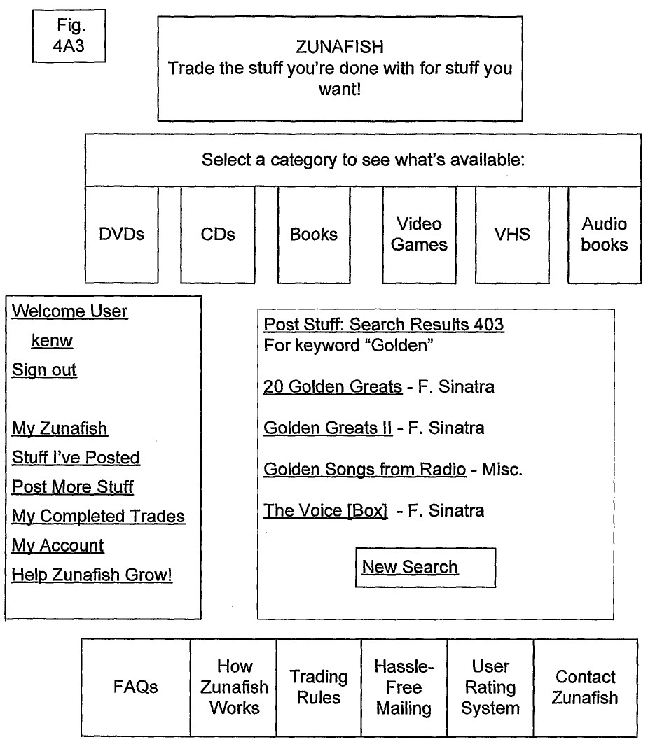

FIG. 3 is a flow diagram of an embodiment of a process that facilitates a trade of a first item owned by a first user for a second item owned by a second user. Specifically, FIG. 3 illustrates bartering program 214 running on server computer 122 to negotiate an electronic bartering transaction between user A 110 operating client computer A 111 and user B 115 operating client computer B 116.

FIG. 3 illustrates a process that begins with user A 110 adding an item (step 302) and user B 111 adding an item (step 304). Server computer 122 receives data communication messages from client computer A 111 and client computer B 116 that include a description of the item being added. Server computer 122 stores each new item in barter database 124 (step 306) and associates each item with the appropriate owner. Since each user may add as many items as necessary, it is to be understood that step 302 and step 304 may be performed as many times as necessary.

To begin the negotiation of an electronic bartering transaction, user A 110 sends a request to server computer 122 for an item owned by one or more users (step 308). Server computer 122 receives the request from user A 110 and stores the request in barter database 124 (step 310). Server computer 122 determines which users own the requested item and sends a notification to each owner of the requested item that a potential trade is in progress (step 312). User B 111 receives the notification and decides whether to accept the potential trade (step 314). If user B 111 decides not to accept the potential trade, the process exits. If user B 111 decides to accept the potential trade, server computer 122 permits user B to browse the list of items owned by user A 110 (step 316 and step 318). Prior to initiation of the trade, server computer 122 does not make accessible to user B 111 the list of items owned by user A 110 or any other user of bartering system 120. If user B 111 does not find any item that is of interest (step 320), the process exits. If user B 11 finds an item that is of interest (step 320), user B 111 sends a trade offer to server computer 122 (step 322). Server computer 122 stores the trade offer (step 324) and sends a notification to the owner of the item of interest that user B 111 is offering to trade for the item of interest owned by user A 110 (step 326). User A 110 considers and decides whether to accept the trade offer (step 328). In various embodiments of the invention, it is possible to create “pending” time limits that establish a time period during which the trade is pending. If the trade has not been accepted when the time limit expires the pending trade may be terminated. Accordingly, the parties may have to start the process over. If user A 110 decides not to accept the trade offer, the process exits. If user A 110 decides to accept the trade offer, user A 110 sends an acceptance to server computer 122 (step 330). Server computer 122 stores the acceptance (step 332) and sends a notification to user A 110 and user B 111 that user A 110 accepted the trade offer (step 334). Subsequently, user A 110 receives the notification and completes the trade (step 336) and user B 111 receives the notification and completes the trade (step 338).

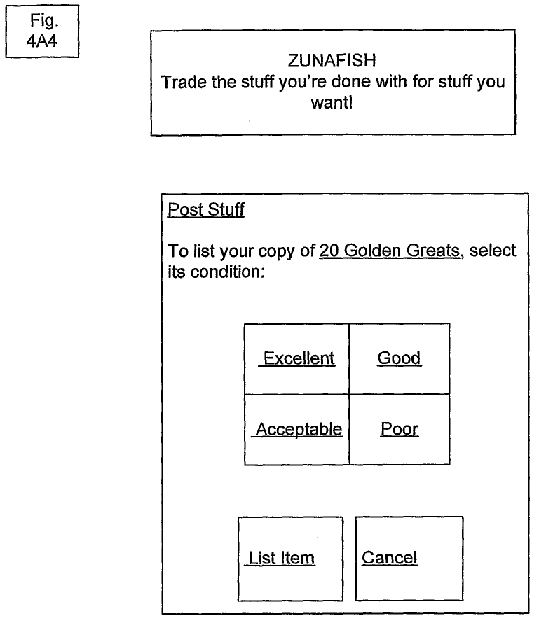

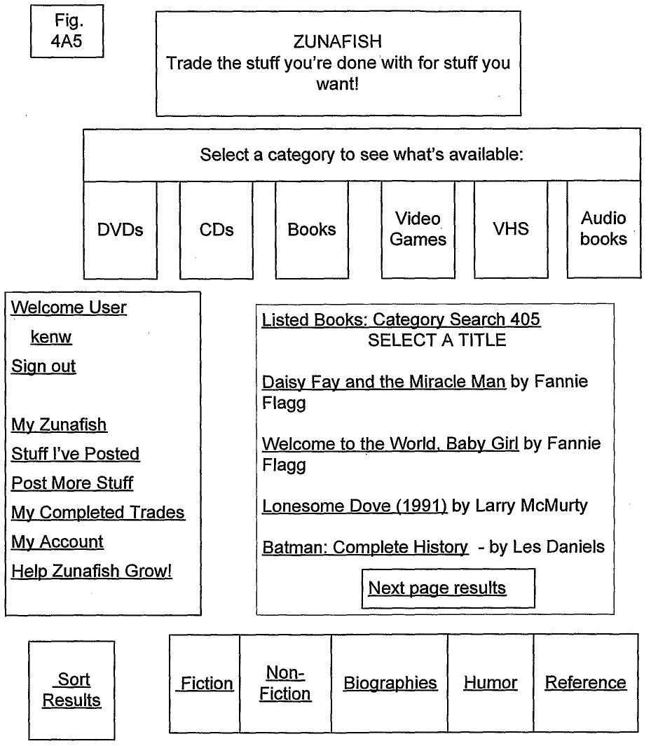

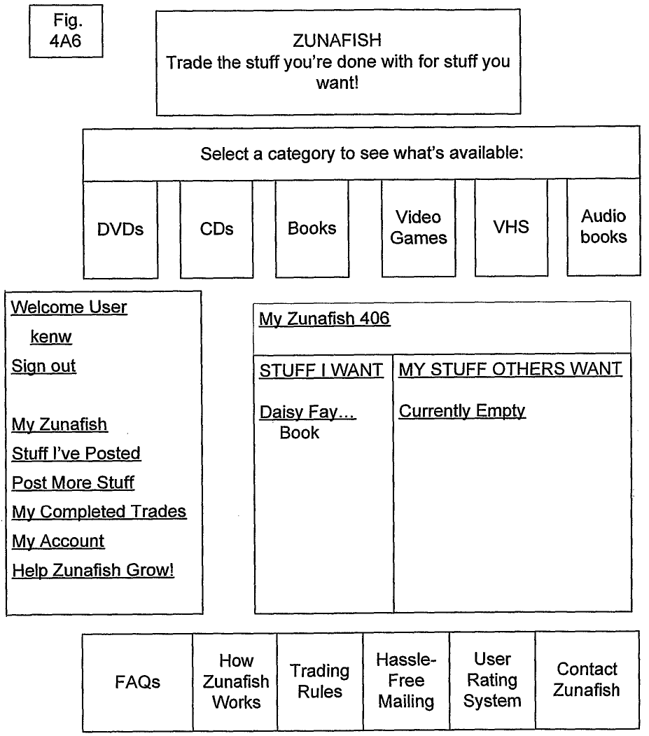

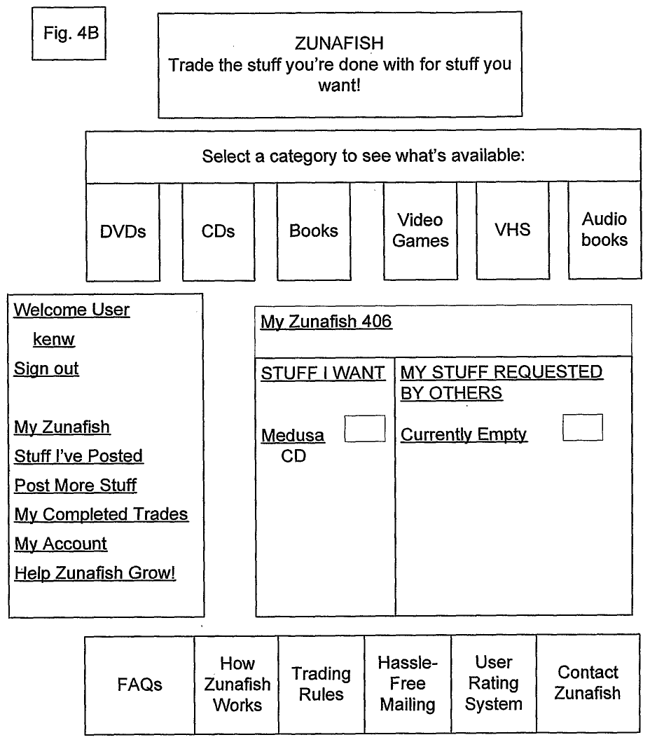

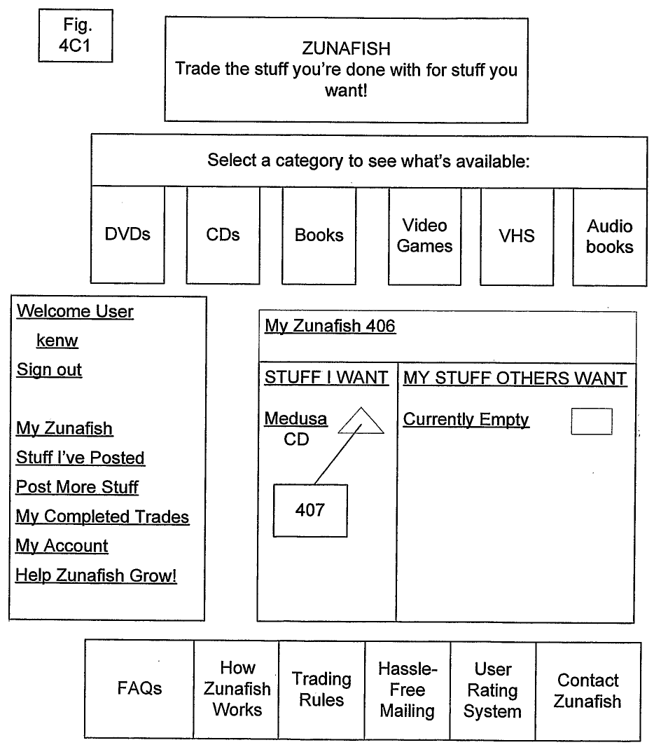

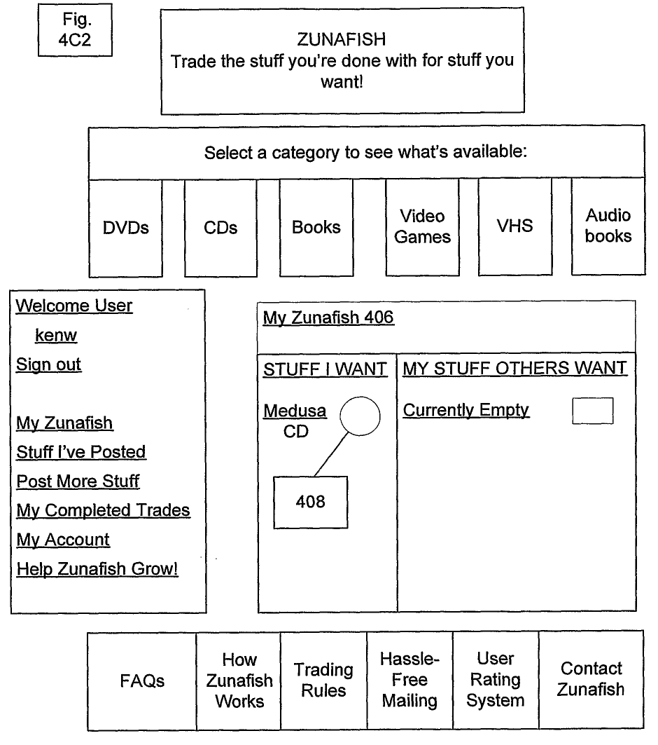

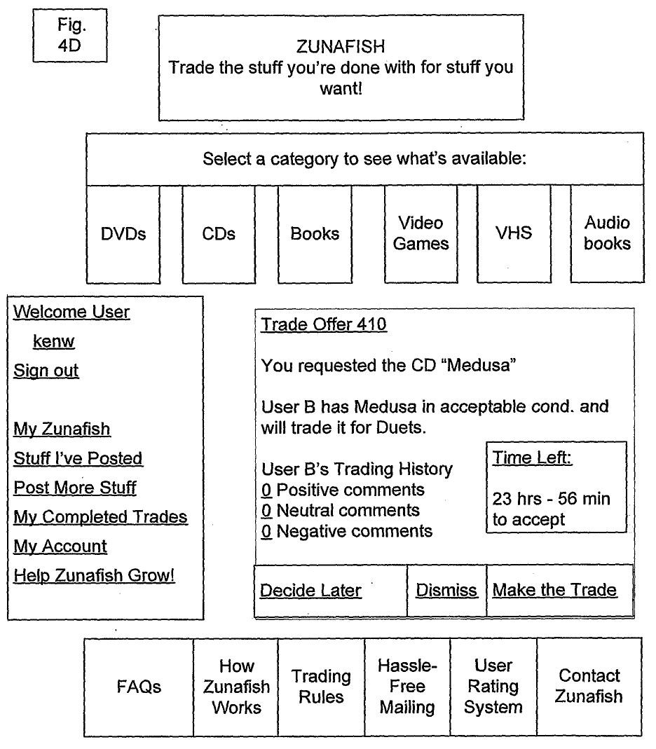

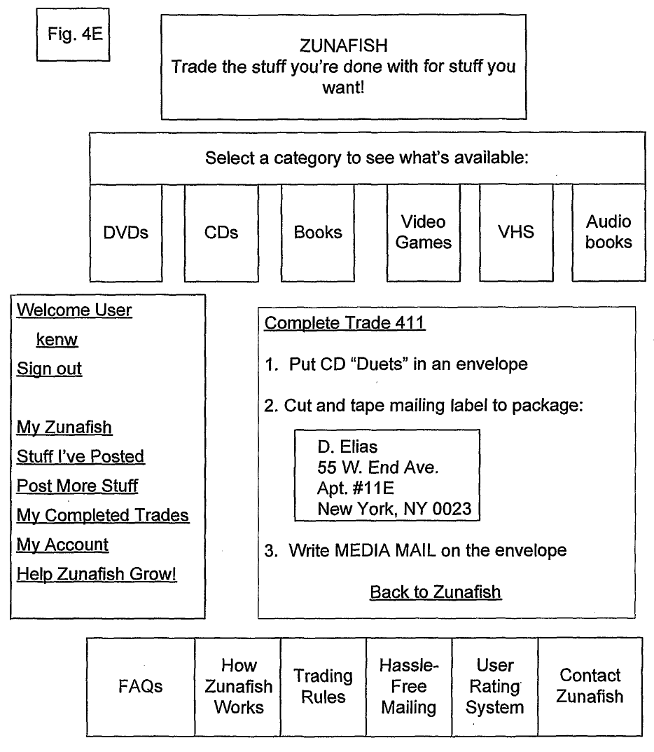

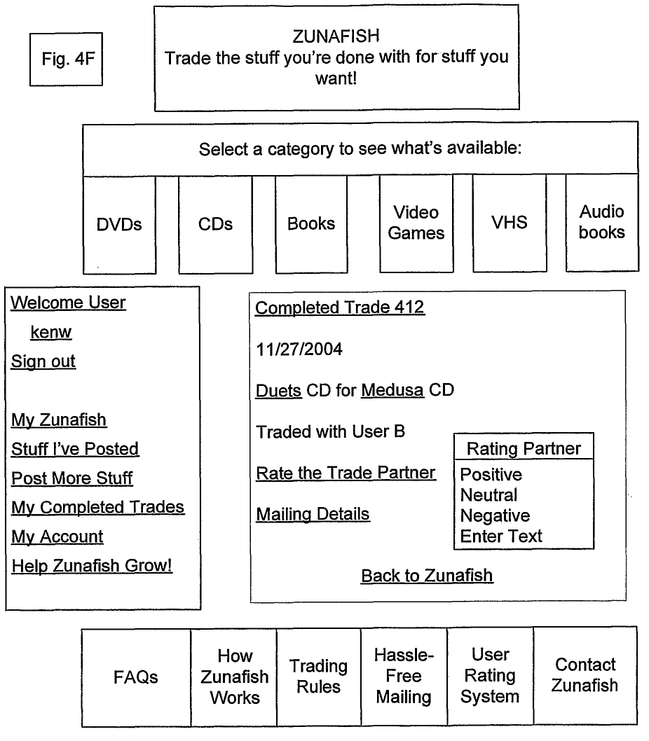

FIGS. 4A1-14G are exemplary screen representations from an implementation of bartering system 120 that demonstrates requesting an item from another user and accepting a trade offer in response. FIG. 4A1 illustrates the “Stuff I've Posted” web page (401) that lists all of the items added by a user, “kenw.”. The list groups the items by type. As shown in FIG. 4A1, the listing includes three items under the category CDs, “20 Golden Greats”, “A New Day Has Come”, and “Duets”. The types of trades supported in the implementation shown in FIG. 4A1 include DVDs, CDs, Books, Video Games, VHS, and Audiobooks. To add/post a new barter item, “kenw” clicks on either of the two “Post More Stuff” links to navigate to a Post More Stuff web page. As shown in FIG. 4A2 (402), for each item added, “kenw” chooses a category from a menu in box 1 “Select the goods category” in “Post More Stuff” (402). “Kenw” may enter titles or keywords, such as “Golden” in box 2 to retrieve a description of the desired item from a local Muze database 126. If the search produces matches, the system lists the resulting items in the Search Results 403, in FIG. 4A3. Upon finding an item to post, “kenw” may click on the item, and choose a condition of the item from a pop-up menu as shown in FIG. 4A3. After selecting the item's condition, the user, “kenw” clicks on the “List Item” button in FIG. 4A4 to add the new item to the “Stuff I've Posted” listing.

To request an item from another user in a category in which he has posted titles, “kenw” clicks on the icon that represents the type of new item (e.g., Books) to navigate to a web page for requesting Books 405 (as in FIG. 4A5). On the Books web page 405, “kenw” either browses the available titles or may enter search terms to search for a specific title from the aggregated collection of all users. If “kenw” finds a title he desires to own, he clicks on it, thus informing the owner(s) of the item of his interest in the item and inviting them to peruse his own Book collection, and causing the title to display on “kenw's” My Zunafish Home Page (“Daisy Fay . . . ” 406 in FIG. 4A6).

FIG. 4B illustrates the Home Page, “My Zunafish” 406 for a bartering system 120. Below the icons that represent the item types (e.g., DVDs, CDs, Books, Video Games, VHS, and Audiobooks), the Home Page 406 includes a status display for the electronic bartering trades associated with a user such as “kenw”, who in the following example is about to engage in a trade involving CDs. The status display has a left and a right portion. The left portion of the status display includes a list of the items that “kenw” has requested from other users, titled “STUFF I WANT”. The right portion of the status display includes a list of the items that other users have requested from “kenw,” titled “MY STUFF REQUESTED BY OTHERS”. Each item displayed in the left portion and the right portion has a status and is associated with a status symbol that displays next to the listed item. As shown in FIG. 4B, the left portion of the status display indicates that “kenw” has requested the item “Medusa” from at least one other member. The status symbol to the right of the item is a rectangle indicating that, as yet, none of the users who have “Medusa” listed in their “Stuff I've Posted” list have responded to “kenw” with a trade offer.

FIG. 4C1 illustrates the Home Page (406) for bartering system 120 after receiving a trade offer from another user. The left portion of the status display shown in FIG. 4C indicates that one of the users who own “Medusa” has responded to “kenw” with a trade offer. This indication is shown by the status symbol changing to a Zunalert 407 (i.e., a triangle). The Zunalert 407 indicates that another user has responded to the item request from “kenw” by finding an item of interest in the collection owned by “kenw” and sending to “kenw” a trade offer. The Zunalert 407 also indicates that “kenw” has 24 hours to respond to the trade offer by the other user. FIG. 4C2 illustrates the Home Page (406) after “kenw” clicks on “Medusa” to examine the trade offer and returns to the Home Page (406) without responding to the trade offer. The status symbol 408 in FIG. 4C2 has changed from a Zunalert 407 to a clock symbol 408 to indicate that a trade timer is counting down and that “kenw” has less than 24 hours to accept the trade offer from the other user.

FIG. 4D illustrates the web page displayed as a result of “kenw” clicking on the item “Medusa” on the Home Page. As shown in FIG. 4D, “bbloom” has the CD “Medusa” in “Acceptable” condition and will trade it for the CD “Duets.” The window “Trade Offer” (410) includes trading statistics for “bbloom.” These statistics detail the ratings given to “bbloom” by his previous trading partners. The trade offer page 410 also includes a countdown expiration timer for the trade offer. If “kenw” decides to make this trade with “bbloom” by clicking the “Make This Trade” link, bartering system 120 will describe, as shown in FIG. 4E, how to complete the trade 411.

FIG. 4F illustrates a “Completed Trade” web page (411). Completed Trade (411) acts as a trade receipt and also is the feedback mechanism for updating the trading statistics for a user. After receiving the item in the mail, “kenw” enters an evaluation of the trade he has just made with “bbloom”. The evaluation may include (as shown in FIG. 4F) selecting a Positive, Neutral, or Negative rating from a pull-down menu and entering text comments.

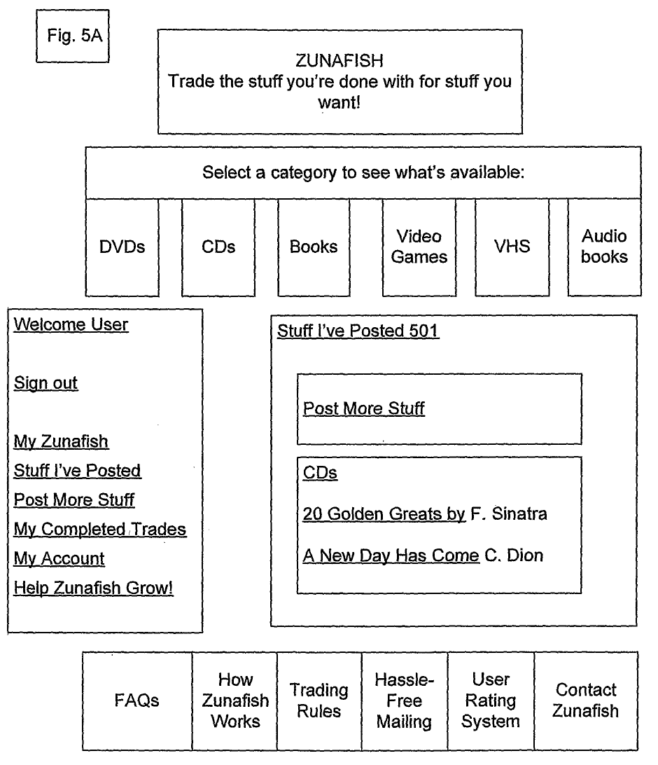

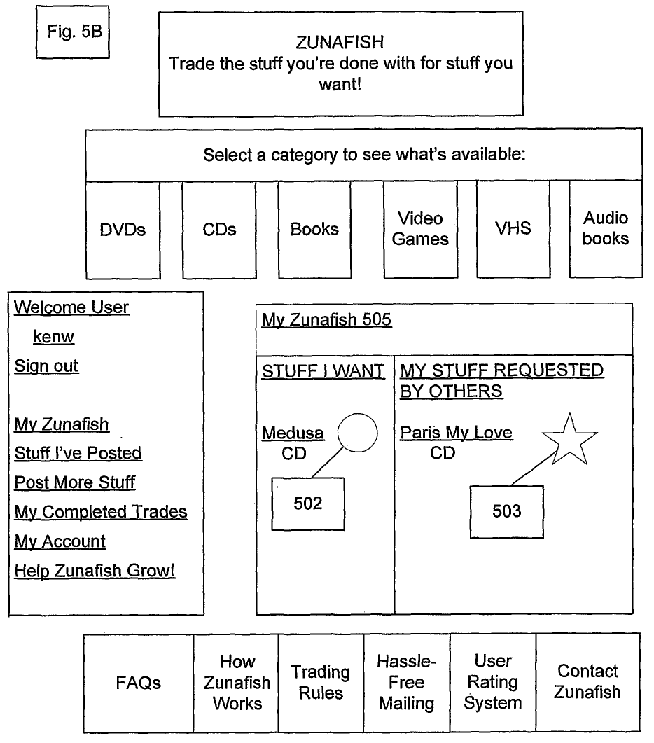

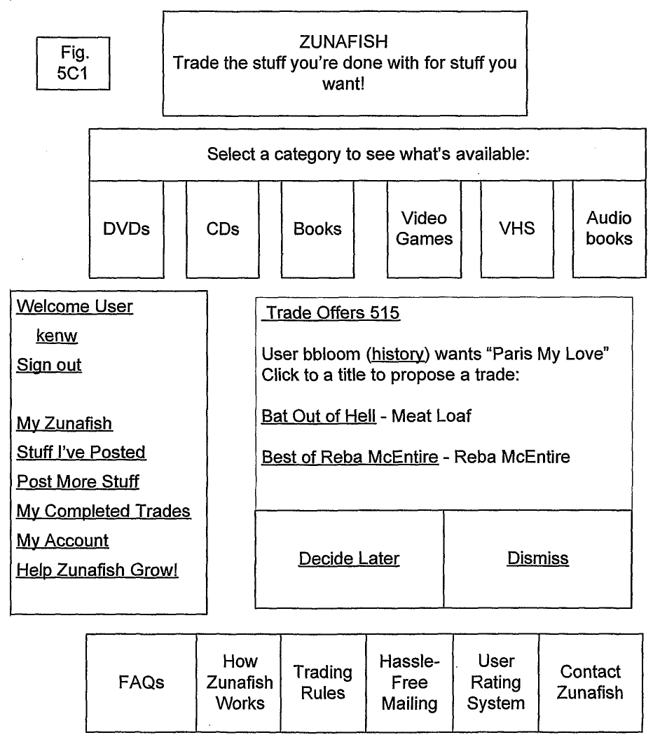

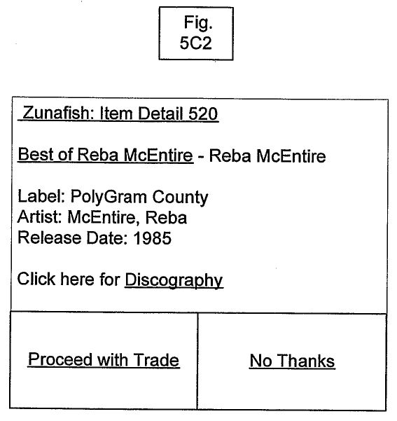

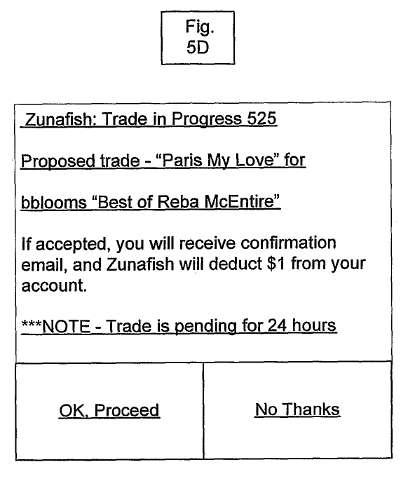

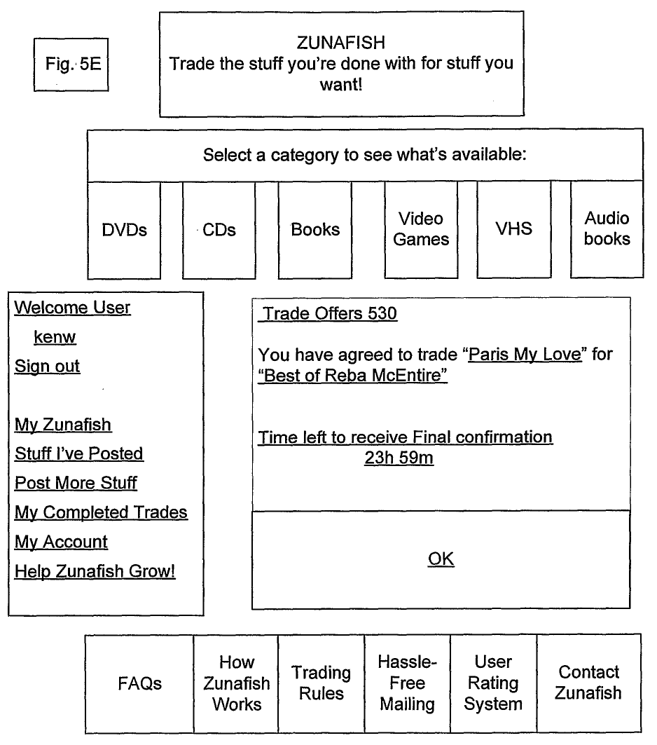

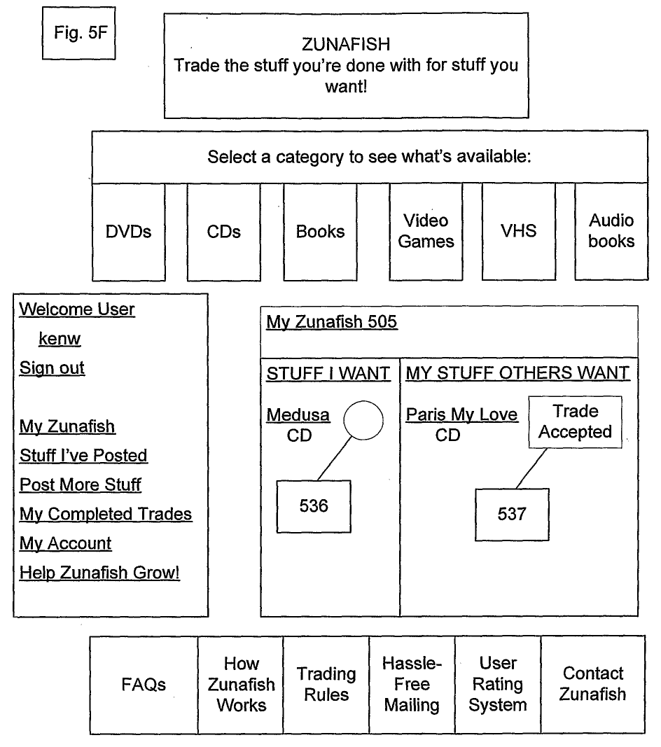

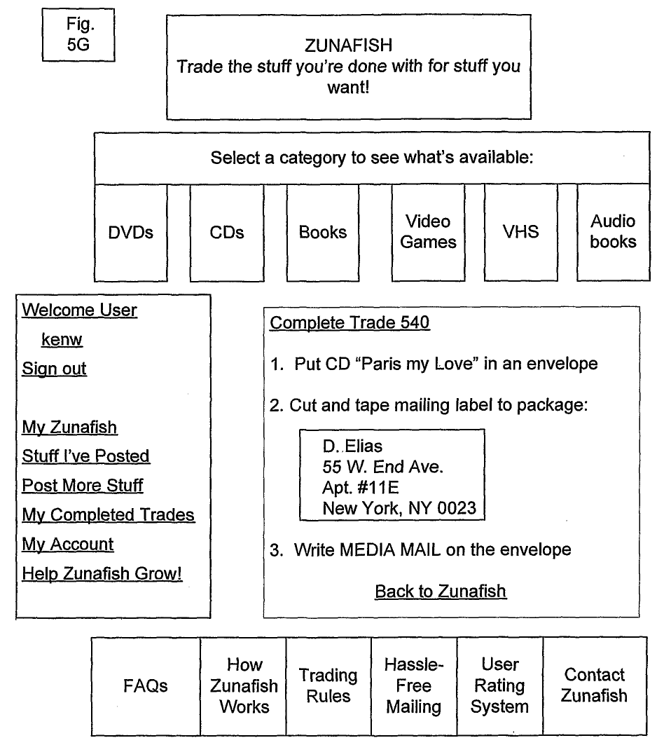

FIGS. 5A-5H are exemplary screen images from an implementation of bartering system 120 that demonstrates receiving a potential trade request from another user and issuing a trade offer in response. FIG. 5A illustrates the “Stuff I've Posted” page (501) that lists all of the items added by user “kenw”. The list is similar to the list shown in FIG. 4A1, but reflects the trade of the item under the category CDs described as “Duets”. Thus, the only items in the list are under the category CDs described as “20 Golden Greats” and “A New Day Has Come”.

FIG. 5B illustrates the Home Page (505) for bartering system 120. Below the icons that represent the item types, the Home Page (505) includes a status display similar to that shown in FIG. 4B. As shown in FIG. 5B, the left portion of the status display indicates that user “kenw” has requested “Medusa” from other users and the status symbol to the right of “Medusa” is a circle 502 to indicate that the trade is complete and awaiting delivery. The right portion of the status display indicates that another user has requested the item described as “Paris My Love” from user “kenw”. The status symbol to the right of “Paris My Love” is a star to indicate that a potential trade is in progress. As shown in FIG. 5C1, by clicking on the CD titled “Paris My Love” in the right portion of the status display, bartering system 120 will display a web page (515) to user “kenw” that lists the CDs that user “bbloom” has available for trading. User “kenw” browses the list and decides that the CD described as “Best Of Reba McEntire” in acceptable condition is interesting. Since the trading statistics associated with user “bbloom” are positive (“kenw” may click on history to view trading statistics), user “kenw” clicks on the item and is presented with the opportunity to send a trade offer to user “bbloom” (FIG. 5C2). Alternately, if the trading statistics associated with user “bbloom” were not positive, user “kenw” may click on the “Dismiss this offer” button to decline the trade offer from user “bbloom”, or user “kenw” may choose the option to Decide Later, as shown in FIG. 5C1. FIG. 5D illustrates a confirmation message (525) that bartering system 120 displays to user “kenw” to confirm that the trade offer should be placed.

FIG. 5E illustrates a web page (530) that bartering system 120 displays to user “kenw” if he clicks on the item “Paris My Love” on his Home Page (505) after receiving the confirmation message shown in FIG. 5D. FIG. 5E informs user “kenw” that he has agreed to trade his “Paris My Love” CD for the “Best Of Reba McEntire” CD owned by user “bbloom” and also shows the time remaining for “bbloom” to accept the trade offer.

FIG. 5F illustrates the Home Page (505) for bartering system 120 after user “bbloom” accepts the trade offer. In the right portion of the status display, the status symbol to the right of the item that user “bbloom” requested, “Paris My Love” has changed to a “Trade Accepted” symbol. The “Trade Accepted” symbol indicates that user “bbloom” has accepted the trade offer shown in FIG. 5E. By clicking on the item, bartering system 120 will describe, as shown in FIG. 5G, how to complete the trade. The system may be configured to create an electronic mail message that user “kenw” will receive as notification that user “bbloom” has accepted the trade offer.

Although the disclosed embodiments describe a fully functioning electronic bartering system and method for facilitating a trade of an item owned by one person connected to a network for an item owned by another person connected to the network, the reader should understand that other equivalent embodiments exist. Since numerous modifications and variations will occur to those who review this disclosure, the electronic bartering system and method is not limited to the exact construction and operation illustrated and disclosed. Accordingly, this disclosure intends all suitable modifications and equivalents to fall within the scope of the claims.

We claim:

1. A system for facilitating a trade of a first item owned by a first user for a second item owned by a second user, the first user and the second user connected to a network, comprising:
a memory device; and
a processor disposed in communication with the memory device, the processor configured to:
receive a request from the first user, the request including an identification of the second item;
allow the second user to access at least one item owned by the first user, said at least one item including the first item;
receive a response from the second user, the response including an identification of the first item; and
receive an acceptance from the first user.

2. The system of claim 1, wherein to receive the request, the processor is further configured to:
store the request; and
send a notification of the request to at least the second user.

3. The system of claim 2, wherein the notification is sent to the second user and all other owners of the item.

4. The system of claim 2, wherein the storing of the request is to a database.

5. The system of claim 1, wherein the allowing of the second user to access said at least one item owned by the first user succeeds the receiving of the request from the first user.

6. The system of claim 1, wherein to allow the second user to access said at least one item owned by the first user, the processor is further configured to:
display a trading history for the first user; and
display said at least one item owned by the first user

7. The system of claim 6, wherein the trading history is a summary of evaluations by traders who were opposite the first user in previous trades.

8. The system of claim 7, wherein the summary includes the rating of trades and the trading partners' comments.

9. The system of claim 6, wherein the display of said at least one item owned by the first user includes a proffered condition of said at least one item.

10. The system of claim 1, wherein to receive the response from the second user, the processor is further configured to:
store the response; and
send a notification of the response to the first user.

11. The system of claim 10, wherein the storing of the response is to a database.

12. The system of claim 1, wherein to receive the acceptance, the processor is further configured to:
store the acceptance; and
send a notification of the acceptance to the second user.

13. The system of claim 1, wherein after the receiving of the acceptance, the processor is further configured to:
associate a time period with the trade,
whereby the first user and the second user confirm the trade during the time period.

14. The system of claim 13, wherein a countdown timer measures the time period.

15. The system of claim 12, wherein the storing of the acceptance is to a database.

16. The system of claim 1, wherein the processor is further configured to:
store said at least one item owned by the first user; and
store at least one item owned by the second user, said at least one item owned by the second user including the second item.

17. The system of claim 1, wherein the processor is further configured to:
receive a first confirmation from the first user; and
receive a second confirmation from the second user, whereby the first confirmation and the second confirmation indicate completion of the trade.

18. The system of claim 1, wherein each item includes a type and a proffered condition.

19. The system of claim 1, wherein the type includes a video media format, an audio media format, a printed media format, or a video game format.

20. A method for facilitating a trade of a first item owned by a first user for a second item owned by a second user, the first user and the second user connected to a network, comprising:
receiving a request from the first user, the request including an identification of the second item;
allowing the second user to access at least one item owned by the first user, said at least one item including the first item;
receiving a response from the second user, the response including an identification of the first item; and
receiving an acceptance from the first user.

21. The method of claim 20, wherein the receiving of the request further comprises:
storing the request; and
sending a notification of the request to at least the second user.

22. The system of claim 20, wherein the notification is sent to the second user and all other owners of the item.

23. The method of claim 21, wherein the storing of the request is to a database.

24. The method of claim 20, wherein the allowing of the second user to access said at least one item owned by the first user succeeds the receiving of the request from the first user.

25. The method of claim 20, wherein the allowing of the second user to access said at least one item owned by the first user further comprises:
displaying a trading history for the first user; and
displaying said at least one item owned by the first user

26. The method of claim 25, wherein the trading history is a summary of evaluations by traders who were opposite the first user in previous trades.

27. The method of claim 26, wherein the summary includes the rating of trades and the trading partners' comments.

28. The method of claim 25, wherein the display of said at least one item owned by the first user includes a proffered condition of said at least one item.

29. The method of claim 20, wherein the receiving of the response from the second user further comprises:
storing the response; and
sending a notification of the response to the first user.

30. The method of claim 29, wherein the storing of the response is to a database.

31. The method of claim 20, wherein the receiving of the acceptance further comprises:
storing the acceptance; and
sending a notification of the acceptance to the second user.

32. The method of claim 20, wherein after the receiving of the acceptance, further comprising:
associating a time period with the trade, whereby the first user and the second user confirm the trade during the time period.

33. The method of claim 32, wherein a countdown timer measures the time period.

34. The method of claim 31, wherein the storing of the acceptance is to a database.

35. The method of claim 20, further comprising:
storing said at least one item owned by the first user; and
storing at least one item owned by the second user, said at least one item owned by the second user including the second item.

36. The method of claim 20, further comprising:
receiving a first confirmation from the first user; and
receiving a second confirmation from the second user, whereby the first confirmation and the second confirmation indicate completion of the trade.

37. The method of claim 20, wherein each item includes a type and a proffered condition.

38. The method of claim 20, wherein the type includes a video media format, an audio media format, a printed media format, or a video game format.

39. A computer program product for facilitating a trade of a first item owned by a first user for a second item owned by a second user, the first user and the second user connected to a network, comprising:
a computer readable medium storing:
program code for receiving a request from the first user, the request including an identification of the second item;
program code for allowing the second user to access at least one item owned by the first user, said at least one item including the first item;
program code for receiving a response from the second user, the response including an identification of the first item; and
program code for receiving an acceptance from the first user.

40. The computer program product of claim 39, wherein the program code for receiving the request further comprises:
program code for storing the request; and
program code for sending a notification of the request to at least the second user.

41. The system of claim 40, wherein the notification is sent to the second user and all other owners of the item.

42. The computer program product of claim 39, wherein the program code for allowing the second user to access said at least one item owned by the first user further comprises:
program code for displaying a trading history for the first user; and
program code for displaying said at least one item owned by the first user

43. The computer program product of claim 39, wherein the program code for receiving the response from the second user further comprises:
program code for storing the response; and
program code for sending a notification of the response to the first user.

44. The computer program product of claim 39, wherein the program code for receiving the acceptance further comprises:
program code for storing the acceptance; and
program code for sending a notification of the acceptance to the second user.

45. The computer program product of claim 39, wherein after the receiving of the acceptance, further comprising:
program code for associating a time period with the trade,
whereby the first user and the second user confirm the trade during the time period.

46. The computer program product of claim 39, further comprising:
program code for storing said at least one item owned by the first user; and
program code for storing at least one item owned by the second user, said at least one item owned by the second user including the second item.

47. The computer program product of claim 39, further comprising:
program code for receiving a first confirmation from the first user; and
program code for receiving a second confirmation from the second user, whereby the first confirmation and the second confirmation indicate completion of the trade.

48. A graphical user interface, comprising:
a first region to display items that a user is requesting from other users; and
a second region to display items that the other users are requesting from the user, wherein the items displayed in the first region and the second region include an indicator to communicate to the user a status of the trade.

49. The graphical user interface of claim 48, wherein for items in the first region the status includes no response, notification of a new offer, a timer indicating the remaining time the offer is valid, notification of the expiration or refusal of an offer and trade complete.

50. The graphical user interface of claim 48, wherein for items in the second region the status includes notification of a new offer, an existing offer awaiting action, a timer indicating the remaining time the offer is valid, notification of the expiration or refusal of an offer, notification of an accepted trade and trade complete.
